(19) United States
(12) Patent Application Publication
(10) Pub. No.: US 2019/0055406 A1
(43) Pub. Date: Feb. 21, 2019

(54) TREATED INORGANIC PARTICULATE MATERIAL FOR IMPROVING PERFORMANCE OF CONSTRUCTION AND ASSEMBLY COMPOUNDS

(71) Applicant: Imerys USA, Inc., Roswell, GA (US)

(72) Inventors: David ANSTINE, Cumming, GA (US); Douglas WICKS, Johns Creek, GA (US); Christopher PAYNTER, Atlanta, GA (US)

(21) Appl. No.: 16/079,233

(22) PCT Filed: Feb. 13, 2017
(86) PCT No.: PCT/US17/17615

§ 371 Date: Aug. 23, 2018

Related U.S. Application Data
(60) Provisional application No. 62/298,711, filed on Feb. 23, 2016.

(51) Int. Cl. C09C 1/02; C09C 3/10; C04B 14/28; C04B 14/20; C04B 14/36; C04B 14/18

(52) U.S. Cl. CPC C09C 1/021; C09C 3/10; C04B 14/28; C04B 2111/00672; C04B 14/365; C04B 14/18; C04B 14/202

(57) ABSTRACT

A composition for use as a construction compound is disclosed. The composition may include an inorganic particulate material treated with at least one surface treatment. The surface treatment may include at least one of a fatty acid, a salt thereof, or an ester thereof, silicone oil, silane, or siloxane. The construction compound may improve the workability and/or surface finish of a construction compound. Methods are also provided, including a method for improving the efficiency of application of a construction compound to a drywall joint.

### CLAIM OF PRIORITY

This PCT International Application claims the benefit of priority of U.S. Provisional Application No. 62/298,711 filed Feb. 23, 2016, the subject matter of which is incorporated herein by reference in its entirety.

### FIELD OF DISCLOSURE

Disclosed herein are compositions for use as improved construction compounds.

### BACKGROUND OF THE DISCLOSURE

Gypsum board, also known as sheetrock or drywall, is widely used in the construction, remodeling and repair of residential homes, commercial buildings, and the like. Drywall is available in various sizes, such as 4×8 foot or 4×12 foot sheets that are typically ½ or ⅝ inches thick. The drywall is generally attached to the wood or steel studs of the infrastructure by nails or screws. Because joints are formed when the drywall is hung, these joints must be covered using drywall joint compound and drywall tape in order to provide an acceptable finish before paint or wallpaper is applied to the walls.

The application of joint compound onto drywall surfaces usually involves several cycles of application, smoothing and drying followed by sanding. The cycle is continued until the desired surface finish is achieved. Additional cycles require bringing workers back onto the job site during subsequent days and added expense. In addition, if necessary, sanding the final coat of the drywall joint compound further increases the overall time needed to finish the drywall joints. Additionally, sanding creates a significant amount of dust.

Other construction compounds besides joint compounds may also contain calcium carbonate and other minerals. For instance, calcium carbonate may be used in coatings, adhesives, sealants, and elastomer formulations hi a quantity typically ranging from 1% to 70% of the total formulation weight. Typically, calcium carbonates are used as fillers to occupy space and reduce formulation costs in CASE (Coating, Adhesive, Sealant, Elastomer) Applications.

Therefore, it may be desirable to provide an improved construction compound for dry wall and CASE applications that will allow for reduced labor in order to achieve the desired surface finish.

### SUMMARY OF THE DISCLOSURE

According to a first aspect, a construction compound including a treated inorganic particulate material comprising a hydrophobic treatment, at least one untreated inorganic particulate material, and a base material is provided. The treated inorganic particulate material may have a d₅₀ smaller than the d₅₀ of the untreated inorganic particulate, such that the treated inorganic particulate material is dispersed among the untreated inorganic particulate material.

According to a second aspect, a construction compound having improved workability, smoother surface finish, decreased permeability, long term dimensional stability, and/or higher sag resistance is provided. The construction compound comprises an inorganic particulate material treated with at least one of a fatty acid, a salt thereof, or an ester thereof, silicone oil, silane, or siloxane and at least one untreated inorganic particulate material. The treated inorganic particulate material may have a d₅₀ smaller than the d₅₀ of the untreated inorganic particulate, such that the treated inorganic particulate material is dispersed among the untreated inorganic particulate material.

According to a third aspect, a method of improving the workability, smoother surface finish, decreased permeability, and/or higher sag resistance of a construction compound is provided. The method comprises providing an inorganic particulate material treated with at least one of a fatty acid, a salt thereof, or an ester thereof, silicone oil, silane, or siloxane and at least one untreated inorganic particulate material in the construction compound. The treated inorganic particulate material may have a d₅₀ smaller than the d₅₀ of the untreated inorganic particulate, such that the treated inorganic particulate material is dispersed among the untreated inorganic particulate material.

According to a fourth aspect, a method of improving the efficiency of application of a construction compound to a building material substrate is provided. The method comprises providing a hydrophobic inorganic particulate material and at least one untreated inorganic particulate material. The treated inorganic particulate material may have a d₅₀ smaller than the d₅₀ of the untreated inorganic particulate, such that the treated inorganic particulate material is dispersed among the untreated inorganic particulate material. The method may further comprise applying the construction compound in fewer coats as compared to a construction compound devoid of the hydrophobic inorganic particulate material.

### DESCRIPTION OF EXEMPLARY EMBODIMENTS

According to some embodiments, a construction compound may include an inorganic particulate material (e.g., a mineral) treated with a hydrophobic treatment (e.g. a surface treatment) and a base material. The at least one surface treatment imparts hydrophobic or water-repellant properties to the inorganic particulate material. In certain embodiments, at least one surface treatment may include at least one of a fatty acid, a salt thereof, or an ester thereof, silicone oil, silane, or siloxane. The treated inorganic particulate material may have a d₅₀ smaller than the d₅₀ of the untreated inorganic particulate, such that the treated inorganic particulate material is dispersed with the untreated inorganic particulate material.

As used herein “construction compound” refers to any material that is set or hardens upon drying or evaporation of a liquid therein (e.g., water) and/or any material that cures or hardens upon activation, occurrence, or completion of a reaction (e.g., moisture curing or two-component reaction/curing). Examples of construction compounds include assembly compounds, drywall compound, joint compound, drywall mud, grout, spackle, mortar, coatings (e.g., paints, exterior paints, interior paints, architectural coatings, light duty industrial OEM and protective coatings, wood coatings, concrete and cementitious coatings), adhesives (e.g., adhesives for tiles, wood floorings, water-borne adhesives, etc.), sealants (e.g., sealants for automotive and construction applications), and elastomers (e.g., elastomers for parking decks, water-proofing, and automotive underbody sound dampening applications, water-borne or solvent born compositions, solvent-free polyurethanes, epoxies, silicones, thermosets, two-part cure systems and cross-linking compounds).

In certain embodiments, the construction compound may comprise an untreated inorganic particulate material blended with the treated inorganic particulate material. In particular embodiments, the construction compound may include a blend of a coarse, untreated inorganic particulate material and fine, treated inorganic particulate material. In certain embodiments, the treated inorganic particulate material and/or the untreated inorganic particulate may include talc, limestone (e.g., ground calcium carbonate (GCC), ground calcite, ground dolomite), chalk, marble, precipitated calcium carbonate, lime, gypsum, diatomaceous earth, perlite, hydrous or calcined kaolin, attapulgite, bentonite, montmorillonite, feldspar, wollastonite, mica, vermiculite, halloysite, quartz, and other natural or synthetic clays, and combinations thereof. In some embodiments, blending a fine, treated inorganic particulate material with a coarser, untreated inorganic particulate results in a construction compound that exhibits some hydrophobic properties and less caking when put in contact with water versus untreated inorganic particulate material alone.

In certain embodiments, the construction compound may be in the form of a dry powder that is adapted to be mixed with water before application. In other embodiments, the construction compound may be in a “ready-mixed” form wherein the base material may include water or a non-aqueous solvent.

In particular embodiments, the inorganic particulate material may include calcium carbonate, such as, for example, marble or limestone (e.g., ground calcite or ground dolomite) or precipitated calcium carbonate. In some embodiments, the inorganic particulate material may include lime. Hereafter, certain embodiments of the invention may tend to be discussed in terms of calcium carbonate, and in relation to aspects where the calcium carbonate is processed and/or treated. The invention should not be construed as being limited to such embodiments. For instance, calcium carbonate may be replaced, either in whole or in part, with, for example, talc, lime, gypsum, diatomaceous earth, perlite, hydrous or calcined kaolin, attapulgite, bentonite, montmorillonite, feldspar, wollastonite, mica, vermiculite, halloysite, quartz, and other natural or synthetic clays.

In certain embodiments, at least one surface treatment is used to modify the surface of the inorganic particulate material. In one embodiment the at least one surface treatment at least partially chemically modifies the surface of the inorganic particulate material by way of at least one surface treating agent. Chemical modification includes, but is not limited to, covalent bonding, ionic bonding, and “weak” intermolecular bonding, such as van der Wawls' interactions. In some embodiments, the at least one surface treatment at least partially physically modifies the surface of the inorganic particulate material. Physical modification includes, but is not limited to, roughening of the material surface, pitting the material surface, or increasing the surface area of the material surface. In further embodiments, the at least one surface treatment at least partially chemically modifies and at least partially physically modifies the surface of the inorganic particulate material. In yet other embodiments, the at least one surface treatment is any chemical or physical modification to the surface of the inorganic particulate material.

In certain embodiments, the at least one fatty acid, salt thereof, or ester thereof may be one or more fatty acid, salt thereof, or ester thereof with a chain length of C8 or greater and may be branched or unbranched. The fatty acid may, for example, be stearic acid or naphthenic acid.

In other embodiments, the surface treatment may be a carboxylate salt, a phosphonate salt, or a sulfonate salt.

In some embodiments, the at least one surface treatment silanizes the inorganic particulate material. The silanizing surface treatment may include at least one siloxane. In general, siloxanes are any of a class of organic or inorganic chemical compounds comprising silicon, oxygen, and often carbon and hydrogen, based on the general empirical formula of R₂SiO, where R may be an alkyl group. Exemplary siloxanes include, but are not limited to, dimethylsiloxane, methylphenylsiloxane, methylhydrogen siloxane, methylhydrogen polysiloxane, methyltrirnethoxysilane, octamethylcyclotetrasiloxane, hexamethyldisiloxane, diphenylsiloxane, and copolymers or blends of copolymers of any combination of monophenylsiloxane units, diphenylsiloxane units, phenylmethylsiloxane units, dimethylsiloxane units, monomethylsiloxane units, vinylsiloxane units, phenylvinylsiloxane units, methylvinylsiloxane units, ethylsiloxane units, phenylethylsiloxane units, ethylmethylsiloxane units, ethylvinylsiloxane units, or diethylsiloxane units.

In some embodiments, the silanizing surface treatment may include at least one silane. In general, silanes and other monomeric silicon compounds have the ability to bond to inorganic materials, such as the inorganic particulate material. The bonding mechanism may be aided by two groups in the silane structure, where, for example, the Si(OR₃) portion interacts with the inorganic particulate material, while the organofunctional (vinyl-, amino-, epoxy-, etc.) group may interact with other materials.

In one embodiment, the inorganic particulate material may be surface-treated with at least one ionic silane. Exemplary ionic silanes include, but are not limited to, 3-(trimethoxysilyl) propyl-ethylenediamine triacetic acid trisodium salt and 3-(trihydroxysilyl)propylmethylposphonate salt. In another embodiment, the inorganic particulate material may be subjected to at least one surface treatment with at least one nonionic silane.

In a further embodiment, the inorganic particulate material may be subjected to at least one surface treatment with at least one silane of Formula (I):

(R¹)ₓSi(R²)₃₋ₓR³ (I)

wherein:
R¹ is any hydrolysable moiety that may chemically react with any active group on the surface of the inorganic particulate material, including, but not limited to, alkoxy, halogen, hydroxy, aryloxy, amino, amide, methacrylate, mercapto, carbonyl, urethane, pyrrole, carboxy, cyano, aminoacyl, acylamino, alkyl ester, and aryl ester;
X has a value between 1 and 3, such that more than one siloxane bond may be formed between the inorganic particulate material and the at least one silane;
R² is any carbon-bearing moiety that does not substantially react or interact with the inorganic particulate material during the treatment process, including, but not limited to, substituted or unsubstituted alkyl, alkenyl, alkaryl, alkcycloalkyl, aryl, cycloalkyl, cycloalkenyl, heteroaryl, heterocyclic, cycloalkaryi, cycloalkenylaryl, alkcycloalkaryl, alkcycloalkenyaryl, and arylalkaryl;
R³ is any organic-containing moiety that remains substantially chemically attached to the silicon atom of Formula (I) once the at least one surface treatment is completed and that is capable of reacting or interacting with an active ingredient, such as, but not limited to, hydrogen, alkyl, alkenyl, alkaryl, alkcycloalkyl, aryl, cycloalkyl, cycloalkenyl, heteroaryl, heterocyclic, cycloalkaryl, cycloalkenylaryl, alkcycloalkaryl, alkcycloalkenyaryl, arylalkaryl, alkoxy, halogen, hydroxy, aryloxy, amino, amide, methacrylate, mercapto, carbonyl, urethane, pyrrole, alkyl ester, aryl ester, carboxy, sulphonate, cyano, aminoacyl, acylamino, epoxy, phosphonate, isothiouronium, thiouronium, alkylamino, quaternary ammonium, trialkylammonium, alkyl epoxy, alkyl urea, alkyl imidazole, or alkyiisothiouronium; wherein the hydrogen of said alkyl, alkenyl, aryl, cycloalkyl, cycloalkenyl, heteroaryl, and heterocyclic is optionally substituted by, for example, halogen, hydroxy, amino, carboxy, or cyano.

In another embodiment, the inorganic particulate material with a hydroxyl-bearing porous surface may be subjected to at least one surface treatment with at least one silane, such that the inorganic particulate material surface is chemically bonded to the at least one silane. In such an embodiment, the surface area of the inorganic particulate material may limit the amount of the bound silane. As a result, it may be preferable to subject the inorganic particulate material to at least one physical surface treatment that increases the surface area of the inorganic particulate material prior to treatment with the at least one silane.

In some embodiments, silanization may proceed according to “wet” or “dry” processes known to the skilled artisan. For example, a “wet” process generally includes reacting the at least one silane onto the inorganic particulate material in at least one solvent (e.g., organic solvent or water). In some embodiments, heat may used in place of, or in addition to, the at least one solvent. Although heat and solvents are not required for a “wet” process, they may improve the reaction rate and promote uniform surface coverage of the treatment. In another embodiment, a “wet” process includes in-line mixing of slurries or liquids during typical silanization processing steps, including but not limited to filtration and drying.

In some embodiments, a “dry” silanization process generally includes reacting at least one silane with the inorganic particulate material in a vapor phase by mixing the at least one silane with the inorganic particulate material and then heating the mixture. In some embodiments, a “dry” silanization process includes reacting at least one silane with the inorganic particulate material in a stirred liquid phase by mixing the at least one silane with the inorganic particulate material and then heating the mixture. In still other embodiments, a “dry” silanization process includes mixing at least one silane with the inorganic particulate material and incubating in a sealed container at elevated temperatures to speed up the surface treatment process. In yet other embodiments, the “dry” silanization process includes mixing the inorganic particulate material and a liquid silane additive, where the amount of silane added is small enough that the reaction mass remains solid-like and can continue to be processed like a dry particulate material.

In one embodiment, the inorganic particulate material may be subjected to at least one surface treatment with at least one silane by adding the at least one silane gradually to a rapidly stirred solvent, which is in direct contact with the inorganic particulate material. In another embodiment, the inorganic particulate material may be subjected to at least one surface treatment with at least one silane by carrying out the treatment in a vapor phase, which causes the vapor of the at least one silane to contact and react with the inorganic particulate material.

According to some embodiments, a surface treatment, such as, for example, silicone oil, silaxane, or silane, may polymerize onto the inorganic particulate material. The treated inorganic particulate material may then be deagglomerated, if needed. According to certain embodiments, the inorganic particulate may be treated with more than one surface treatment.

In certain embodiments, the inorganic particulate material may have a fineness of about 5.5 Hegman or less, as measured by ASTM D1210. For instance, the inorganic particulate may have a fineness of about 5.0 Hegman or less, or 4.5 Hegman or less.

In some embodiments, the inorganic particulate material may have a brightness of 95 or less, as measured using Hunter Colorimeter Models D-25A-9 or DP 9000. In certain embodiments, the inorganic particulate material may have a brightness of 93 or less, or 91 or less.

In certain embodiments, the fine, treated inorganic particulate material may have a BET surface area of at least about 3 square meters/gram. For example, the inorganic particulate material may have a BET surface area of at least about 4 square meters/gram, at least about 5 square meters/gram, or at least about 6 square meters/gram.

In some embodiments, the coarse, untreated inorganic particulate material may have a BET surface area of at least about 0.3 square meters/gram. For example, the inorganic particulate material may have a BET surface area of at least about 0.4 square meters/gram, at least about 0.5 square meters/gram, or at least about 0.6 square meters/gram.

In some embodiments, the treated inorganic particulate material may be a ground inorganic particulate material, such as a dry ground treated inorganic particulate material or a wet ground treated inorganic particulate material.

In some embodiments, the untreated inorganic particulate material may be ground inorganic particulate material, such as a dry ground inorganic particulate material or a wet ground inorganic particulate material.

In some embodiments, the blended treated inorganic particulate material and untreated inorganic particulate material has a range of contact angles from about 10 to about 150 degrees. According to some embodiments, the blended material has a range of contact angles from about 25 to about 125 degrees, from about 50 to about 100 degrees, or from 90 to about 150 degrees.

Without wishing to be bound by a particular theory, it is believed that the ratio of the treated inorganic particulate material to untreated inorganic particulate material may be proportioned to vary the amount of un-reacted surface treatment in the blends. In certain embodiments, surface-treated inorganic particulate material may be used to provide a hydrophobic property to the construction compound. By pre-blending the treated inorganic particulate and the untreated inorganic particulate before addition to the construction compound base material, the blended composition has a hydrophobicity that prevents or reduces moisture pick-up of the construction compound.

Without wishing to be bound by a particular theory, addition of a surface treatment, such as stearic acid, may result in minimal “free acid” after treatment, The reaction of stearic acid with an inorganic particulate material having a calcium carbonate surface may create calcium or magnesium stearate. As the melting point of stearic acid is approximately 157° F. (69.4° C.), and the melting point of calcium stearate is approximately 311° F. (155° C.), processing of the inorganic particulate blend or the construction compound is minimally or absent of any effects (e.g., volitalization at lower temperatures) from the “free acid”.

According to some embodiments, calcium carbonate may be combined (e.g., blended) at room temperature with stearic acid (or salts thereof, esters thereof, or mixtures thereof) and water in an amount greater than about 0.1% by weight relative to the total weight of the mixture (e.g., in the form of a cake-mix). The mixture may be blended at a temperature sufficient for at least a portion of the stearic acid to react (e.g., sufficient for a majority of the stearic acid to react with at least a portion of the calcium carbonate). For instance, the mixture may be blended at a temperature sufficient such that at least a portion of the stearic acid may coat at least a portion of the calcium carbonate (e.g., the surface of the calcium carbonate).

In some embodiments, the mixture may be blended at a temperature high enough to melt the stearic acid. For example, the mixture may be blended at a temperature ranging from about 149° F. (65° C.) to about 392° F. (200° C.). In other embodiments, the mixture may be blended at a temperature ranging from about 149° F. (65° C.) to about 302° F. (150° C.), for example, at about 248° F. (120° C.). in further embodiments, the mixture may be blended at a temperature ranging from about 149° F. (65° C.) to about 212° F. (100° C.). in still other embodiments, the mixture may be blended at a temperature ranging from about 149° F. (65° C.) to about 194° F. (90° C.), hi further embodiments, the mixture may be blended at a temperature ranging from about 158° F. (70° C.) to about 194° F. (90° C.).

In certain embodiments, the amount of surface treatment may be combined with the inorganic particulate material, such as, for example, calcium carbonate, below, at, or in excess of, a monolayer concentration. “Monolayer concentration,” as used herein, refers to an amount sufficient to form a monolayer on the surface of the inorganic particles. Such values will be readily calculable to one skilled in the art based on, for example, the surface area of the inorganic particles.

In some embodiments, the surface treatment may be added to calcium carbonate in an amount greater than or equal to about one times the monolayer concentration. In other embodiments, the surface treatment may be added in an amount in excess of about one times the monolayer concentration, for example, two times to six times the monolayer concentration.

Also, without wishing to be bound by a particular theory, the median particle sizes of the coarse untreated portions of the construction compounds may be chosen based on their potential to pack with the median particle size of the specific treated fine portions of the calcium carbonate used in that blend. The advantage of blending the smaller particles with the larger particles is that the voids between the larger particles that would wick moisture into the blend are reduced or avoided. In certain embodiments, particle-packing practice may be used to inhibit the wicking action of surface water through the compositions.

in construction compounds, the improved particle-packing and the disinclination to wick moisture provides better control of moisture reactive or moisture sensitive systems, early water resistance, prevents the continued absorbssion of moisture after cure and/or drying, better rheology, and/or improved dimensional stability or long term stability (e.g., during cycling).

In certain embodiments, the inorganic particles may be characterized by a mean particle size (d₅₀) value, defined as the size at which 50 percent of the calcium carbonate particles have a diameter less than or equal to the stated value. Particle size measurements, such as d₅₀, may be carried out by any means now or hereafter known to those having ordinary skill in the art.

Particle size characteristics described herein are measured via sedimentation of the particulate material in a fully dispersed condition in an aqueous medium using a Sedigraph 5100 particle size analyzer, supplied by Micromeritics Instruments Corporation, Norcross. Ga., USA. The Sedigraph 5100 provides measurements and a plot of the cumulative percentage by weight of particles having a size, referred to in the art as the “equivalent spherical diameter” (esd).

According to some embodiments, the amount of free stearic acid associated with a stearic acid-treated calcium carbonate composition may be less than about 20% relative to the monolayer concentration. According to other embodiments, the amount of free stearic acid associated with a stearic acid-treated calcium carbonate composition may be less than about 15% free stearic acid. According to further embodiments, the amount of free stearic acid associated with a stearic acid-treated calcium carbonate composition may be less than about 10% free stearic acid, less than about 7% free stearic acid, less than about 6% free stearic acid, less than about 5% free stearic acid, less than about 4% free stearic acid, less than about 3% free stearic acid, less than about 2% free stearic acid, or less than about 1% free stearic acid. In still further embodiments, no free stearic acid may be associated with a stearic acid-treated calcium carbonate composition. “No free stearic acid,” as used herein, refers to no stearic acid being detectable by the ToF-SIMS, TGA, and/or DSC techniques described herein.

According to some embodiments, the treated inorganic particulate material and the untreated inorganic particulate material have the same particle size distribution (psd). The psd of the fine particles may be similar to, or the same as, the psd of the coarse portion of the construction compound.

An exemplary construction compound is now described. The construction compound may be such that a minimum of 90% of the particles passes through a 325 mesh. In some embodiments, the d₅₀ ranges from about 10 to about 50 microns; no more than about 0.4 wt % surface treatment is present; and the ratio of the fine treated portion to the coarse untreated portion ranges from 1:99 to 75:25. The fine portion may be treated with stearic acid, silicone oil, siloxane, or silane. For the stearic acid treatment, it is preferred to have reacted stearate on the inorganic particulate material, as it has a higher melting point (311° F.) relative to unreacted (free) stearic acid (157° F.).

In certain embodiments, the treatment level ranges from 0.01 wt % to 5.0 wt %, for example, from 0.1 wt % to 2.5 wt % based on the weight of the inorganic particulate material.

For instance, the fatty acid, salt thereof, or ester thereof may be present in treatment level ranges from 0.1 wt % to 2.5 wt % based on the weight of the inorganic particulate material. The fatty acid, salt thereof, or ester thereof may be present in an amount of not more than 0.2 wt %, not more than 0.3 wt %, not more than 0.4 wt %, not more than 0.5 wt %, not more than 0.6 wt %, not more than 0.7 wt %, not more than 0.8 wt %, not more than 0.9 wt %, not more than 1.0 wt %, not more than 1.1 wt %, not more than 1.2 wt %, not more than 1.25 wt %, not more than 1.3 wt %, not more than 1.4 wt %, not more than 1.5 wt %, not more than 1.6 wt %, not more than 1.7 wt %, not more than 1.8 wt %, not more than 1.9 wt %, not more than 2.0 wt %, not more than 2.1 wt %, not more than 2.2 wt %, not more than 2.3 wt %, not more than 2.4 wt %, or not more than 2.5 wt % based on the weight of the inorganic particulate material.

For instance, the silicone oil, siloxane, or silane may be present in treatment level ranges from 0.01 wt % to 5,0 wt % based on the weight of the inorganic particulate material. The silicon oil, siloxane or silane may be present in an amount of not more than 0.05 wt %, not more than 0.1 wt %, not more than 0.2 wt %, not more than 0.3 wt %, not more than 0.4 wt %, not more than 0.5 wt %, not more than 0.6 wt %, not more than 0.7 wt %, not more than 0.8 wt %, not more than 0.9 wt %, not more than 1.0 wt %, not more than 1.1 wt %, not more than 1.2 wt %, not more than 1.25 wt %, not more than 1.3 wt %, not more than 1.4 wt %, not more than 1.5 wt %, not more than 1.6 wt %, not more than 1.7 wt %, not more than 1.8 wt %, not more than 1.9 wt %, not more than 2.0 wt %, not more than 2.1 wt %, not more than 2.2 wt %, not more than 2.3 wt %, not more than 2.4 wt %, not more than 2.5 wt %, not more than 3.0 wt %, not more than 3.5 wt %, not more than 4.0 wt %, not more than 4.5 wt %, or not more than 5.0 wt % based on the weight of the inorganic particulate material.

In certain embodiments, the fine treated inorganic particulate material d₅₀ ranges from 1 to 15 microns. In other embodiments, the fine treated inorganic particulate material d₅₀ ranges from 0.5 to 75 microns, from 1 to 60 microns, from 1 to 50 microns, or from 1 to 30 microns.

In certain embodiments, the ratio of treated inorganic particulate material to untreated inorganic particulate material ranges from about 1:99 to about 99:1, for example, from about 3:97 to about 97:3, 5:95 to about 95:5, from about 10:90 to about 90:10, from about 20:80 to about 80:20, from about 25:75 to about 75:25, or less than about 50:50.

According to some embodiments, the untreated inorganic particulate material d₅₀ ranges from 3 to 75 microns, for example, from 10 to 75 microns, from 12 to 75 microns, from 20 to 75 microns, from 25 to 75 microns, from 30 to 75 microns, from 5 to 50 microns, or from 10 to 50 microns.

According to other embodiments, the untreated inorganic particulate material d₁₀₀ ranges from 15 microns to 800 microns. According to certain embodiments, the untreated inorganic particulate material d₅ is greater than 0.5 microns. For instance, the untreated inorganic particulate material may have a particle size particle size distribution where the D₁₀₀ is 800 microns and the d₅ is 0.5 microns. In another embodiment, the untreated inorganic particulate material d₁₀₀ is 300 and the d₅ is 0.5 microns. In yet another embodiment, the untreated inorganic particulate material d₁₀₀ is 15 and the d₅ is 0.5 microns.

In some embodiments, the ground calcium carbonate may be prepared by attrition grinding. “Attrition grinding,” as used herein, refers to a process of wearing down particle surfaces resulting from grinding and shearing stress between the moving grinding particles. Attrition can be accomplished by rubbing particles together under pressure, such as by a gas flow.

In some embodiments, the attrition grinding may be performed autogenously, where the calcium carbonate particles are ground only by other calcium carbonate particles.

In another embodiment, the calcium carbonate may be ground by the addition of a grinding media other than calcium carbonate. Such additional grinding media can include ceramic particles (e.g., silica, alumina, zirconia, and aluminum silicate), plastic particles, or rubber particles.

In some embodiments, the calcium carbonate may be ground in a mill. Exemplary mills include those described in U.S. Pat. Nos. 5,238,193 and 6,634,224, the disclosures of which are incorporated herein by reference, As described in these patents, the mill may comprise a grinding chamber, a conduit for introducing the calcium carbonate into the grinding chamber, and an impeller that rotates in the grinding chamber thereby agitating the calcium carbonate.

In some embodiments, the calcium carbonate is dry ground, where the atmosphere in the mill is ambient air. In some embodiments, the calcium carbonate may be wet ground.

In some embodiments, the blended treated and untreated calcium carbonate may have a range of contact angles from 10 to 150 degrees, from 25 to 125 degrees, from 50 to 100 degrees, or from 90 to 150 degrees, as measured by a test according to ASTM D7334-08, For example, a stearate treated calcium carbonate may be blended with an untreated calcium carbonate in a ratio (treated:untreated) of 12.5:87.5. The treated calcium carbonate may be treated with 1.15 wt % of stearate and may have a d₅₀ value of 3.3 microns, as measured by Microtrac laser light diffraction, The untreated calcium carbonate may have a d₅₀ value of 22.5 microns, as measured by a SERIGRAPH 5100. The contact angle of the blended composition may be measured according to ASTM D7334-08. The exemplary blended composition has a contact angle of 93 degrees at 35% relative humidity, and 95.5 degrees at 98% relative humidity.

In other embodiments, the construction compound may comprise a treated calcium carbonate having a d₅₀ value of at least 3.0 microns and an untreated calcium carbonate having a d₅₀ value of at least 18 microns,

In some embodiments, a feed calcium carbonate (prior to milling) may comprise calcium carbonate sources chosen from calcite, limestone, chalk, marble, dolomite, or other similar sources. Ground calcium carbonate particles may be prepared by any known method, such as by conventional grinding techniques discussed above and optionally coupled with classifying techniques, e.g., jaw crushing followed by roller milling or hammer milling and air classifying or mechanical classifying.

The ground calcium carbonate may be further subjected to an air sifter or hydrocyclone. The air sifter or hydrocyclone can function to classify the ground calcium carbonate and remove a portion of residual particles greater than 20 microns, According to some embodiments, the classification can be used to remove residual particles greater than 10 microns, greater than 30 microns, greater than 40 microns, greater than 50 microns, or greater than 60 microns. According to some embodiments, the ground calcium carbonate may be classified using a centrifuge, hydraulic classifier, or elutriator.

In some embodiments, the ground calcium carbonate disclosed herein is free of dispersant, such as a polyacrylate. In another embodiment, a dispersant may be present in a sufficient amount to prevent or effectively restrict flocculation or agglomeration of the ground calcium carbonate to a desired extent, according to normal processing requirements. The dispersant may be present, for example, in levels up to about 1% by weight. Examples of dispersants include poiyelectrolytes such as polyacrylates and copolymers containing poiyacrylate species, especially polyacrylate salts (e.g., sodium and aluminium optionally with a group II metal salt), sodium hexametaphosphates, non-ionic polyol, polyphosphoric acid, condensed sodium phosphate, non-ionic surfactants, alkanolamine, and other reagents commonly used for this function.

A dispersant may be selected from conventional dispersant materials commonly used in the processing and grinding of inorganic particulate materials, such as calcium carbonate. Such dispersants will be recognized by those skilled in this art. Dispersants are generally water-soluble salts capable of supplying anionic species, which in their effective amounts may adsorb on the surface of the inorganic particles and thereby inhibit aggregation of the particles. The unsolvated salts may suitably include alkali metal cations, such as sodium, Solvation may in some cases be assisted by making the aqueous suspension slightly alkaline, Examples of suitable dispersants also include water soluble condensed phosphates, for example, polymetaphosphate salts (general form of the sodium salts: (NaPO₃)ₓ), such as tetrasodium metaphosphate or so-called “sodium hexametaphosphate” (Graham's salt); water-soluble salts of polysilicic acids; polyelectrolytes; salts of homopolymers or copolymers of acrylic acid or methacrylic acid; and/or salts of polymers of other derivatives of acrylic acid, suitably having a weight average molecular mass of less than about 20,000. Sodium hexametaphosphate and sodium polyacrylate, the latter suitably having a weight average molecular mass in the range of about 1,500 to about 10,000, are preferred.

In certain embodiments, the production of the ground calcium carbonate includes using a grinding aid, such as propylene glycol, or any grinding aid known to those skilled in the art.

According to some embodiments, the ground calcium carbonate may be combined with a base material. The base material may be selected from the group of materials consisting of water, polymer, attapulgite, spackle, mortar, and combinations thereof. In certain embodiments, the base material may comprise a plasticizer, diisodecyl phthalate (DIDP), silane terminated hybrid polymers such as polyether, and/or acrylic co-polymers.

In some embodiments, a construction compound may include multiple treated inorganic particulate materials. As one example, a construction compound may include first, second, and third inorganic particulate materials, the first and second materials each having a different hydrophobic treatment and the third material being untreated. Construction compounds may also include multiple untreated inorganic particulate materials, such as, for example, calcium carbonate, lime, gypsum, diatomaceous earth, perlite, hydrous or calcined kaolin, attapulgite, bentonite, montmorillonite, feldspar, wollastonite, mica, vermiculite, halloysite, quartz, or other natural or synthetic clays.

In certain embodiments, the construction compound may be used as a construction compound, e.g., a drywall joint compound, having improved workability and/or surface finish. In view of this improved workability and/or surface finish, the application of the construction compound efficiency is also improved. In other embodiments, the construction compound may have a lower permeability, an improved sag resistance (e.g., improved rheology), higher dirt pick resistance, early water resistance, adhesion and corrosion resistance, and improved durability.

For instance, the construction compound may have a permeability at least 1% less than a construction compound devoid of the an inorganic particulate material treated with a hydrophobic treatment (e.g. a surface treatment) and the untreated inorganic particulate material, in which the treated inorganic particulate material has a d₅₀ smaller than the d₅₀ of the untreated inorganic particulate. In other embodiments, the construction compound may have a permeability at least 10% less than a construction compound devoid of the an inorganic particulate material treated with a hydrophobic treatment (e.g. a surface treatment) and the untreated inorganic particulate material, in which the treated inorganic particulate material has a d₅₀ smaller than the d₅₀ of the untreated inorganic particulate. In yet other In other embodiments, the construction compound may have a permeability at least 20% less than a construction compound devoid of the an inorganic particulate material treated with a hydrophobic treatment (e.g. a surface treatment) and the untreated inorganic particulate material, in which the treated inorganic particulate material has a d₅₀ smaller than the d₅₀ of the untreated inorganic particulate. The permeability of the construction compound may be measured by any known method, including ASTM D1653.

According to certain embodiments, the construction compound may have a sag resistance at least 1% greater than a construction compound devoid of the an inorganic particulate material treated with a hydrophobic treatment (e.g. a surface treatment) and the untreated inorganic particulate material, in which the treated inorganic particulate material has a d₅₀ smaller than the d₅₀ of the untreated inorganic particulate. In other embodiments, the construction compound may have a sag resistance at least 10% greater than a construction compound devoid of the an inorganic particulate material treated with a hydrophobic treatment (e.g. a surface treatment) and the untreated inorganic particulate material, in which the treated inorganic particulate material has a d₅₀ smaller than the d₅₀ of the untreated inorganic particulate. In yet other In other embodiments, the construction compound may have a sag resistance at least 20% greater than a construction compound devoid of the an inorganic particulate material treated with a hydrophobic treatment (e.g. a surface treatment) and the untreated inorganic particulate material, in which the treated inorganic particulate material has a d₅₀ smaller than the d₅₀ of the untreated inorganic particulate. For instance, the construction compound may have at least a 15% to 60% improvement of sag resistance as compared to a construction compound devoid of the an inorganic particulate material treated with a hydrophobic treatment (e.g. a surface treatment) and the untreated inorganic particulate material, in which the treated inorganic particulate material has a d₅₀ smaller than the d₅₀ of the untreated inorganic particulate. The sag resistance of the construction compound may be measured by any known method, including ASTM D4400.

Additional exemplary embodiments may include:
1. A construction composition comprising a first inorganic particulate material and a base material, wherein the construction composition further comprises a second inorganic particulate material and the first inorganic particulate material has received a hydrophobic treatment.
2. The composition of embodiment 1, wherein the second inorganic particulate material is not treated with a hydrophobic treatment.
3. The composition of embodiment 1 or 2, wherein the second inorganic particulate material is untreated.
4. The composition of any of embodiments 1-3, wherein the first inorganic particulate material has a BET specific surface area less than 10 m²/g.
5. The composition any of embodiments 1-4, wherein the first inorganic particulate material is ground calcium carbonate.
6. The composition of embodiment 5, wherein the ground calcium carbonate is ground limestone, ground calcite, ground dolomite, or combinations thereof.
7. The composition of any of embodiments 1-6, wherein the second inorganic particulate material is calcium carbonate.
8. The composition of any of embodiments 1-7, wherein the second inorganic particulate material comprises at least one of calcium carbonate, lime, gypsum, diatomaceous earth, perlite, hydrous or calcined kaolin, attapulgite, bentonite, montmorillonite, feldspar, wollastonite, mica, vermiculite, halloysite, quartz, or other natural or synthetic clays.
9. The composition of any of embodiments 1-8, wherein the ratio of first inorganic particulate material to second inorganic particulate material ranges from about 1:99 to about 99:1.
10. The composition of any of embodiments 1-9, wherein the ratio of first inorganic particulate material to second inorganic particulate material ranges from about 25:75 to about 75:25.
11. The composition of any of embodiments 1-10, wherein the first inorganic particulate material has a d₅₀ ranging from about 0.7 to 75 microns.
12. The composition of any of embodiments 1-11, wherein the second inorganic particulate material has a d₅₀ ranging from about 3 to 75 microns.
13. The composition of any of embodiments 1-12, wherein the hydrophobic treatment comprises at least one fatty acid, salt thereof, or ester thereof with a chain length of C8 or greater.
14. The composition of embodiment 13, wherein the fatty add comprises stearic add.
15. The composition of embodiment 13 or 14, wherein the fatty acid, salt thereof, or ester thereof is present in an amount not greater than about 2.5% by weight of the inorganic particulate material.
16. The composition of any of embodiments 1-15, wherein hydrophobic treatment comprises silicone oil, silane, or siloxane present in an amount not greater than about 5.0% by weight of the inorganic particulate material.

17. The composition of any of embodiments 1-16, wherein each of the first and second inorganic particulate materials has a fineness of about 5.5 Hegman or less.
18. The composition of any of embodiments 1-17 wherein each of the first and second inorganic particulate materials has a brightness of 95 or less.
19. The composition of any of embodiments 1-17 wherein the each of the first and second inorganic particulate materials has a BET surface area of at least about 0.3 square meters/gram.
20. The composition of any of embodiments 1-19, wherein the hydrophobic treatment comprises siloxane chosen from the group consisting of: dimethylsiloxane, methylphenylsiloxane, methylhydrogen siloxane, methylhydrogen polysiloxane, methyltrimethoxysilane, octamethylcyclotetrasiloxane, hexamethyldisiloxane, diphenylsiloxane, and copolymers or blends of copolymers of any combination of monophenylsiloxane units, diphenyisiloxane units, phenylmethylsiloxane units, dimethylsiloxane units, monomethylsiloxane units, vinylsiloxane units, phenylvinylsiloxane units, methylvinylsiloxane units, ethylsiloxane units, phenylethylsiloxane units, ethylmethylsiloxane units, ethylvinyisiloxane units, diethylsiloxane units, and combinations thereof.
21. The composition of any of embodiments 1-20, wherein the hydrophobic treatment comprises an ionic silane.
22. The composition of any of embodiments 1-21, wherein the hydrophobic treatment comprises a nonionic silane.
23. The composition of any of embodiments 1-22, wherein the hydrophobic treatment comprises at least one of 3-(trimethoxysilyl)propyl-ethylenediamine triacetic acid trisodium salt or 3-(trihydroxysilyl)propylmethylposphonate salt.
24. The composition of any of embodiments 1-23, wherein the hydrophobic treatment comprises a silane of the formula:

(R¹)ₓSi(R²)₃₋ₓR³,

wherein R¹ comprises a hydrolysable moiety, R² comprises a carbon-bearing moiety, and R³ comprises an organic-containing moiety.
25. The composition of embodiment 24, wherein the hydrolysable moiety is chosen from the group consisting of: alkoxy, halogen, hydroxy, aryloxy, amino, amide, methacrylate, mercapto, carbonyl, urethane, pyrrole, carboxy, cyano, aminoacyl, acylamino, alkyl ester, and aryl ester.

26. The composition of any of embodiments 24-25, wherein the carbon-bearing moiety is chosen from the group consisting of: substituted or unsubstituted alkyl, alkenyl, alkaryl, alkcycloalkyl, aryl, cycloalkyl, cycloalkenyl, heteroaryl, heterocyclic, cycloalkaryl, cycloalkenylaryl, alkcycloalkaryl, alkcycloalkenyaryl, and arylalkaryl.
27. The composition of any of embodiments 24-26, wherein the organic-containing moiety is chosen from the group consisting of: hydrogen, alkyl, alkenyl, alkaryl, alkcycloalkyl, aryl, cycloalkyl, cycloalkenyl, heteroaryl, heterocyclic, cycloalkaryl, cycloalkenylaryl, alkcycloalkaryl, alkcycloalkenyaryl, arylalkaryl, alkoxy, halogen, hydroxy, aryloxy, amino, amide, methacrylate, mercapto, carbonyl, urethane, pyrrole, alkyl ester, aryl ester, carboxy, sulphonate, cyano, aminoacyl, acylamino, epoxy, phosphonate, isothiouronium, thiouronium, alkylamino, quaternary ammonium, trialkylammonium, alkyl epoxy, alkyl urea, alkyl imidazole, or alkylisothiouronium; wherein the hydrogen of said alkyl, alkenyl, aryl, cycloalkyl, cycloalkenyl, heteroaryl, and heterocyclic is optionally substituted by, for example, halogen, hydroxy, amino, carboxy, or cyano.

Embodiments of methods consistent with the invention may include improving the workability and/or surface finish of a construction compound by providing a treated inorganic particulate material and an untreated inorganic particulate material in the construction compound. Providing the treated and untreated inorganic particulate materials may include mixing them together to form a construction compound.

Treated and untreated inorganic particulate materials may be mixed, for example, at a production facility that produces construction compound, at a job site, or at another location. A contractor may, for example, mix a “quick dry” additive containing a treated inorganic particulate material with an off-the-shelf construction compound containing an untreated inorganic particulate material at a job site. Further, in some embodiments, treated and untreated inorganic particulate materials may be mixed by an end user, such as worker or home owner, just before use of a construction compound. Other embodiments may include bulk mixing of treated and untreated inorganic particulate materials, either at a job site or during manufacture of a construction compound.

Some embodiments may include providing an inorganic particulate material treated with at least one of a fatty acid, a salt thereof, or an ester thereof, silicone oil, silane, or siloxane for inclusion in a construction compound.

Further, some embodiments may include methods of improving the efficiency of application of a construction compound to a drywall joint. Such exemplary methods may include providing a hydrophobic inorganic particulate material and an untreated inorganic particulate material and applying the construction compound in fewer coats as compared to a construction compound devoid of the hydrophobic inorganic particulate material.

### EXAMPLES

Example 1

A treated calcium carbonate having a d₅₀ of 3 microns and treated with stearate was blended with an untreated calcium carbonate having a d₅₀ of 18 microns at a ratio of 12.5 to 87.5. The moisture uptake of the treated calcium carbonate was 0.01%. The moisture uptake of the untreated calcium carbonate was 0.13%. The moisture uptake of the blend was 0.05%. The theoretical moisture pickup of the blend is 0.115% (i.e., (0.13%×0.125)+(0.01%×0.875)). Thus, more than an additive effect (i.e., a synergistic effect) is seen in improving the moisture uptake by producing a blend of treated and untreated calcium carbonate, in which the treated inorganic particulate material has a d₅₀ smaller than the d₅₀ of the untreated inorganic particulate. Such a synergistic blend of materials can be used to improve the workability, surface finish, permeability, sag resistance (e.g., rheology), dirt pick resistance, early water resistance, adhesion, corrosion resistance, and/or durability of construction compounds.

### Example 2

A stearate-treated calcium carbonate was blended with an untreated calcium carbonate in a ratio (treated:untreated) of 12.5:87.5, The treated calcium carbonate was treated with 1.15 wt % of stearate and had a d₅₀ value of 3.0 microns. The untreated calcium carbonate had a d₅₀ value of 18 microns. The pre-blended calcium carbonate was added to a DIDP base material to form a roof coating. The water content of the roof coating relative to DIDP was 7.9%. The sag resistance was 24 Mils and a water vapor permeability as measured by ASTM D1653 was 10.32 perms (4.52 grains/ft²/h). In contrast, a roof coating including only the untreated calcium carbonate in the same amount as the treated:untreated blend had a sag resistance of 14 Mil and a water vapor permeability of 13.13 perms (5.76 grains/ft²/h).

Other embodiments of the invention will be apparent to those skilled in the art from consideration of the specification and practice of the invention disclosed herein, It is intended that the specification and examples be considered as exemplary only, with a true scope and spirit of the invention being indicated by the following claims.

1. A construction composition comprising:
a first inorganic particulate material;
a second inorganic particulate material; and
a base material,
wherein the first inorganic particulate material has received a hydrophobic treatment, and
wherein the first inorganic particulate material has a d₅₀ smaller than the d₅₀ of the second inorganic particulate, such that the first inorganic particulate material is dispersed among the second inorganic particulate material.

2. The composition of claim 1, wherein the first inorganic particulate material has a BET specific surface area less than 10 m²/g.

3. The composition of claim 1, wherein the first inorganic particulate material is ground calcium carbonate.

4-5. (canceled)

6. The composition of claim 1, wherein the second inorganic particulate material comprises at least one of calcium carbonate, lime, gypsum, diatomaceous earth, perlite, hydrous or calcined kaolin, attapulgite, bentonite, montmorillonite, feldspar, wollastonite, mica, vermiculite, halloysite, quartz, or other natural or synthetic clays.

7. The composition of claim 1, wherein the ratio of first inorganic particulate material to second inorganic particulate material ranges from about 1:99 to about 99:1.

8. (canceled)

9. The composition of claim 1, wherein the first inorganic particulate material has a d₅₀ ranging from about 0.7 to 75 microns.

10. The composition of claim 1, wherein the second inorganic particulate material has a d₅₀ ranging from about 3 to 75 microns.

11. The composition of claim 1, wherein the hydrophobic treatment comprises at least one of the following: at least one fatty acid, salt thereof, or ester thereof with a chain length of C8 or greater.

12-13. (canceled)

14. The composition of claim 1, wherein hydrophobic treatment comprises silicone oil, silane, siloxane chosen from the group consisting of:
dimethylsiloxane, methylphenylsiloxane, methylhydrogen siloxane, methylhydrogen polysiloxane, methyltrimethoxysilane, octamethylcyclotetrasiloxane, hexamethyldisiloxane, diphenylsiloxane, and copolymers or blends of copolymers of any combination of monophenylsiloxane units, diphenyisiloxane units, phenylmethylsiloxane units, dimethylsiloxane units, monomethylsiloxane units, vinylsiloxane units, phenylvinylsiloxane units, methylvinylsiloxane units, ethylsiloxane units, phenylethylsiloxane units, ethylmethylsiloxane units, ethylvinylsiloxane units, diethylsiloxane units; and combinations thereof.

15. (canceled)

16. The composition of claim 1, wherein each of the first and second inorganic particulate materials has a brightness of 95 or less.

17. The composition of claim 1, wherein the each of the first and second inorganic particulate materials has a BET surface area of at least about 0.3 square meters/gram.

18-20. (canceled)

21. The composition of claim 1, wherein the hydrophobic treatment comprises at least one of 3-(trimethoxysilyl) propyl-ethylenediamine triacetic acid trisodium salt or 3-(trihydroxysilyl)propylmethylposphonate salt.

22. The composition of claim 1, wherein the hydrophobic treatment comprises a silane of the formula:
(R¹)ₓSi(R²)₃₋ₓR³,
wherein R¹ comprises a hydrolysable moiety, R² comprises a carbon-bearing moiety, and R³ comprises an organic-containing moiety.

23. The composition of claim 22, wherein the hydrolysable moiety is chosen from the group consisting of: alkoxy, halogen, hydroxy, aryloxy, amino, amide, methacrylate, mercapto, carbonyl, urethane, pyrrole, carboxy, cyano, aminoacyl, acylamino, alkyl ester, and aryl ester.

24. The composition of claim 22, wherein the carbon-bearing moiety is chosen from the group consisting of: substituted or unsubstituted alkyl, alkenyl, alkaryl, alkcycloalkyl, aryl, cycloalkyl, cycloalkenyl, heteroaryl, heterocyclic, cycloalkaryl, cycloalkenylaryl, alkcycloalkaryl, alkcycloalkenyaryl, and arylalkaryl.

25. The composition of claim 22, wherein the organic-containing moiety is chosen from the group consisting of: hydrogen, alkyl, alkenyl, alkaryl, alkcycloalkyl, aryl, cycloalkyl, cycloalkenyl, heteroaryl, heterocyclic, cycloalkaryl, cycloalkenylaryl, alkcycloalkaryl, alkcycloalkenyaryl, arylalkaryl, alkoxy, halogen, hydroxy, aryloxy, amino, amide, methacrylate, mercapto, carbonyl, urethane, pyrrole, alkyl ester, aryl ester, carboxy, sulphonate, cyano, aminoacyl, acylamino, epoxy, phosphonate, isothiouronium, thiouronium, alkylamino, quaternary ammonium, trialkylammonium, alkyl epoxy, alkyl urea, alkyl imidazole, or alkylisothiouronium; wherein the hydrogen of said alkyl, alkenyl, aryl, cycloalkyl, cycloalkenyl, heteroaryl, and heterocyclic is optionally substituted by, for example, halogen, hydroxy, amino, carboxy, or cyano.

26. (canceled)

27. The composition of claim 1, wherein the second inorganic particulate material is untreated.

28. A construction compound having improved workability and/or surface finish, comprising:
an inorganic particulate material treated with at least one of a fatty acid, a salt thereof, or an ester thereof, silicone oil, silane, or siloxane; and
an untreated inorganic particulate material,
wherein the treated inorganic particulate material has a d₅₀ smaller than the d₅₀ of the untreated inorganic particulate, such that the treated inorganic particulate material is dispersed among the untreated inorganic particulate material.

29. A method of improving the workability and/or surface finish of a construction compound comprising,
providing an inorganic particulate material treated with at least one of a fatty acid, a salt thereof, or an ester thereof, silicone oil, silane, or siloxane and untreated inorganic particulate material in the construction compound,
wherein the treated inorganic particulate material has a d₅₀ smaller than the d₅₀ of the untreated inorganic particulate, such that the treated inorganic particulate material is dispersed among the untreated inorganic particulate material.

30. (canceled)

31. A method of improving the efficiency of application of a construction compound to a drywall joint, the method comprising:
providing a hydrophobic inorganic particulate material and an untreated inorganic particulate material; and
applying the construction compound in fewer coats as compared to a construction compound devoid of the hydrophobic inorganic particulate material.

32. (canceled)
